(19) United States
(12) Patent Application Publication
(10) Pub. No.: US 2026/0269543 A1
(43) Pub. Date: Sep. 10, 2026

(54) Terminal Module, Electrical Connection Module, Electrical Connection Assembly and Connector

(71) Applicants: Tyco Electronics (Shanghai) Co., Ltd., Shanghai (CN); TE Connectivity Japan G.K., Kawasaki-shi (JP)

(72) Inventors: Yangjin (Ivan) Tian, Shanghai (CN); Katsuhiko KOBAYASHI, Kawasaki-shi (JP)

(73) Assignees: Tyco Electronics (Shanghai) Co., Ltd., Shanghai (CN); TE Connectivity Japan G.K., Kawasaki-shi (JP)

(21) Appl. No.: 19/557,800

(22) Filed: Mar. 5, 2026

(30) Foreign Application Priority Data
Mar. 5, 2025 (CN) 202510261429.4

(51) Int. Cl. H01R 13/6597; H01R 4/02; H01R 13/24; H01R 13/405; H01R 13/50; H01R 13/6471; H01R 13/6585

(52) U.S. Cl. CPC H01R 13/6597; H01R 4/023; H01R 4/027; H01R 13/2442; H01R 13/405; H01R 13/50; H01R 13/6471; H01R 13/6585

(57) ABSTRACT

A terminal module comprises a row of terminals and a terminal holder. The row of terminals includes multiple pairs of signal terminals and multiple grounding terminals arranged in a transverse direction, with one grounding terminal set between adjacent pairs of signal terminals. Each terminal comprises a cantilever portion and a welding portion opposite in a longitudinal direction, and a fixing portion located between the cantilever portion and the welding portion. The terminal holder is injection molded onto the fixing portions of the row of terminals, so that the row of terminals and the terminal holder become an integrated piece. Multiple windows corresponding to the multiple pairs of signal terminals are formed on the terminal holder. The windows penetrate the terminal holder in a height direction, so that a part of the fixing portions of each pair of signal terminals is exposed through the window.

### CROSS-REFERENCE TO RELATED APPLICATION

This application claims the benefit of Chinese Patent Application No. CN202510261429.4 filed on Mar. 5, 2025 in the State Intellectual Property Office of China, the whole disclosure of which is incorporated herein by reference.

### FIELD OF THE INVENTION

The disclosure relates to a terminal module, an electrical connection module comprising the terminal module, an electrical connection assembly comprising the electrical connection module, and a connector comprising the electrical connection assembly.

### BACKGROUND OF THE INVENTION

In the prior art, the terminal module of a connector typically includes a row of terminals and a terminal holder injection molded onto the fixing portions of the row of terminals. In the prior art, the fixing portion of the differential signal terminal in a row of terminals is completely wrapped in the terminal holder, which reduces the signal integrity of the connector. In addition, in the prior art, the terminal module of the connector only includes a single grounding strip, which is soldered to the grounding terminals in a row of terminals. The grounding effect of a single grounding strip is poor and cannot meet the requirements of high-speed signal transmission.

### SUMMARY OF THE INVENTION

According to an embodiment of the present disclosure, a terminal module comprises a row of terminals and a terminal holder. The row of terminals includes multiple pairs of signal terminals and multiple grounding terminals arranged in a transverse direction, with one grounding terminal set between adjacent pairs of signal terminals. Each terminal comprises a cantilever portion and a welding portion opposite in a longitudinal direction, and a fixing portion located between the cantilever portion and the welding portion. The terminal holder is injection molded onto the fixing portions of the row of terminals, so that the row of terminals and the terminal holder become an integrated piece. Multiple windows corresponding to the multiple pairs of signal terminals are formed on the terminal holder. The windows penetrate the terminal holder in a height direction, so that a part of the fixing portions of each pair of signal terminals is exposed through the window.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a terminal module according to an exemplary embodiment of the present invention when viewed from the top;

FIG. 2 shows an illustrative exploded view of a terminal module according to an exemplary embodiment of the present invention when viewed from the top;

FIG. 3 shows another illustrative exploded view of a terminal module according to an exemplary embodiment of the present invention when viewed from the top;

FIG. 4 shows a transverse cross-sectional view of a terminal module according to an exemplary embodiment of the present invention when viewed from the top;

FIG. 5 shows an exploded sectional view of a terminal module according to an exemplary embodiment of the present invention when viewed from the top;

FIG. 6 shows an illustrative perspective view of a terminal module according to an exemplary embodiment of the present invention when viewed from the bottom;

FIG. 7 shows an illustrative exploded view of a terminal module according to an exemplary embodiment of the present invention when viewed from the bottom;

FIG. 8 shows another illustrative exploded view of a terminal module according to an exemplary embodiment of the present invention when viewed from the bottom;

FIG. 9 shows a transverse cross-sectional view of a terminal module according to an exemplary embodiment of the present invention when viewed from the bottom;

FIG. 10 shows an illustrative exploded view of a terminal module and cable according to an exemplary embodiment of the present invention;

FIG. 11 shows an illustrative perspective view of a terminal module and cable according to an exemplary embodiment of the present invention;

FIG. 12 shows an illustrative perspective view of an electrical connection module according to an exemplary embodiment of the present invention;

FIG. 13 shows an illustrative exploded view of an electrical connection assembly according to an exemplary embodiment of the present invention; and

FIG. 14 shows an illustrative perspective view of an electrical connection assembly according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal module comprises: a row of terminals, each terminal comprising a cantilever portion and a welding portion opposite in a longitudinal direction, and a fixing portion located between the cantilever portion and the welding portion; and a terminal holder which is injection molded onto the fixing portions of the row of terminals, so that the row of terminals and the terminal holder become an integrated piece. The row of terminals includes multiple pairs of signal terminals and multiple grounding terminals arranged in a transverse direction, with one grounding terminal set between adjacent pairs of signal terminals, multiple windows corresponding to the multiple pairs of signal terminals are formed on the terminal holder, and the windows penetrate the terminal holder in a height direction, so that a part of the fixing portions of each pair of signal terminals is exposed through the window.

According to another embodiment, an electrical connection module comprises the above terminal module, and multiple cables arranged in a transverse direction. The signal cables of the multiple cables are respectively soldered to the top surfaces of the welding portions of the multiple signal terminals of the terminal module, and the grounding cables of the multiple cables are respectively soldered to the top surfaces of the welding portions of the multiple grounding terminals of the terminal module.

According to another embodiment of the present disclosure, an electrical connection assembly comprises two electrical connection modules assembled together.

According to yet another general concept of the present disclosure, there is provided a connector. The connector comprises a connector housing, and the above electrical connection assembly inserted into the connector housing.

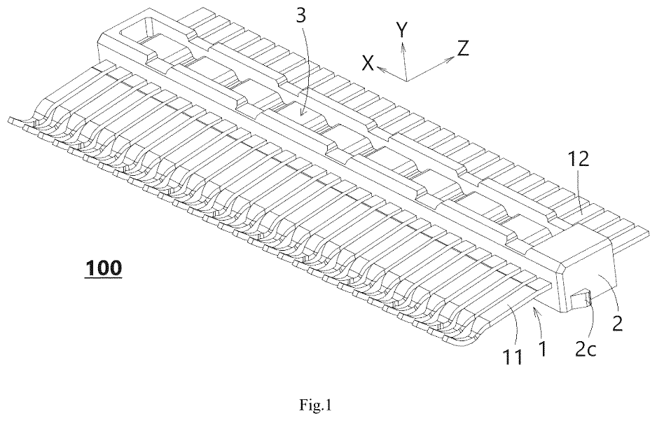

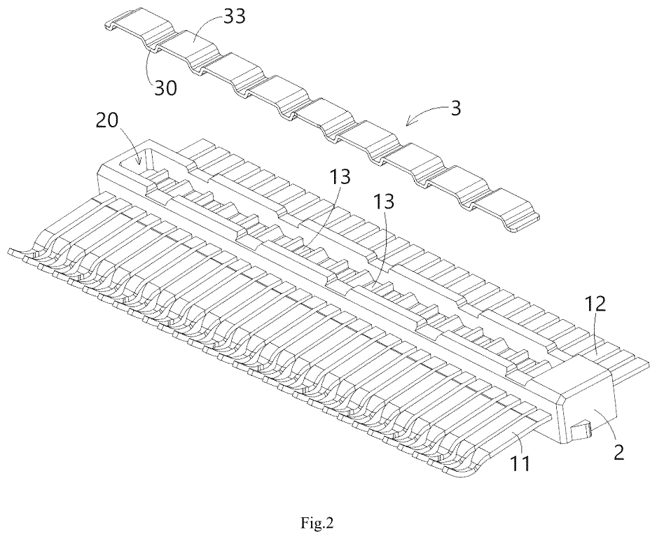

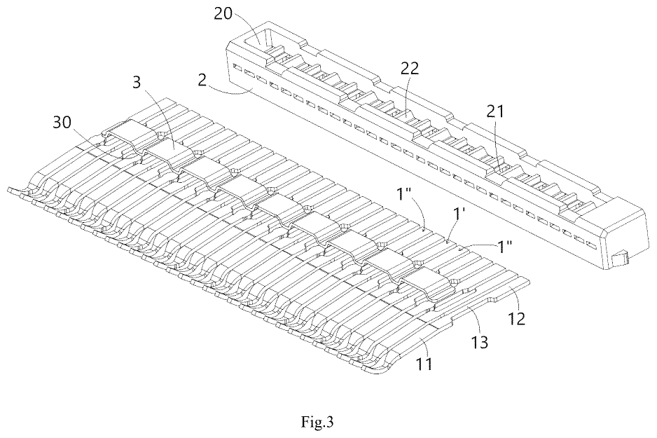

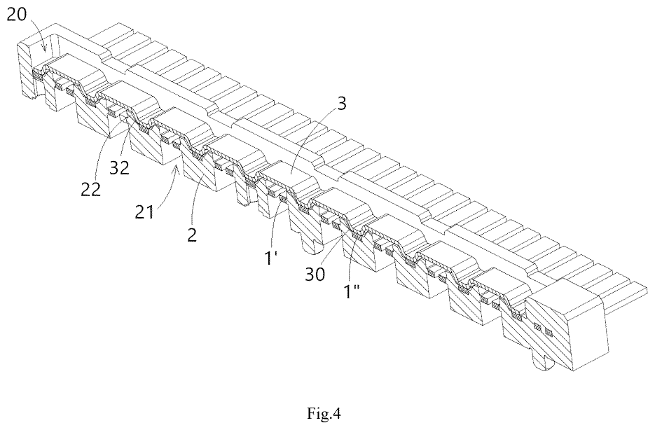

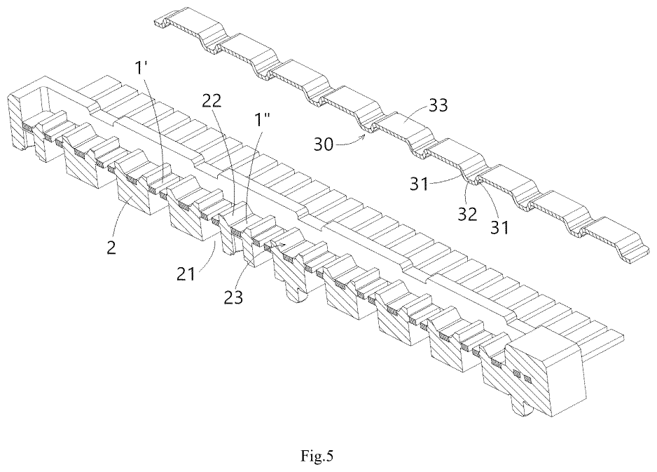

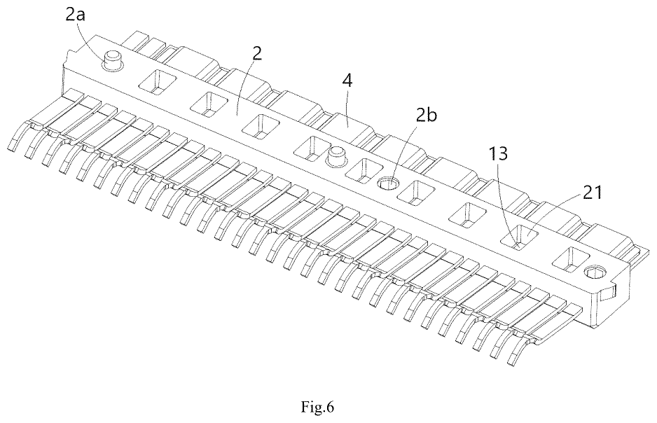

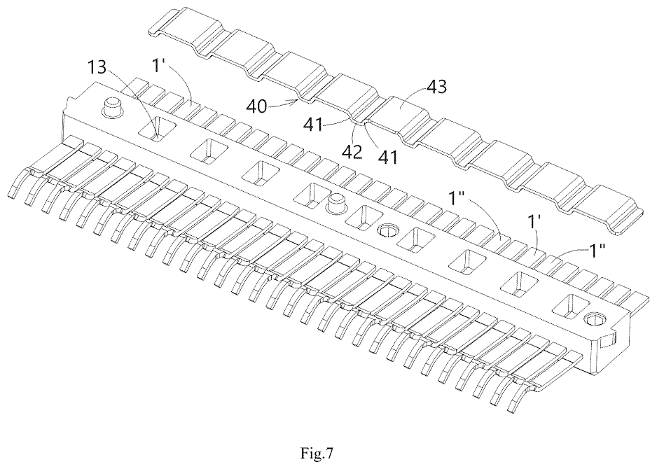

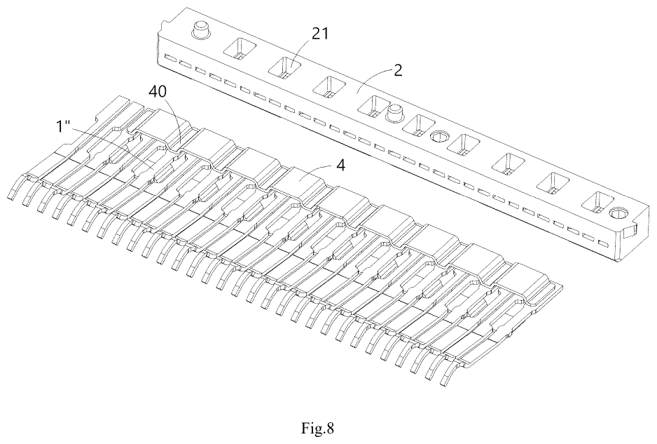

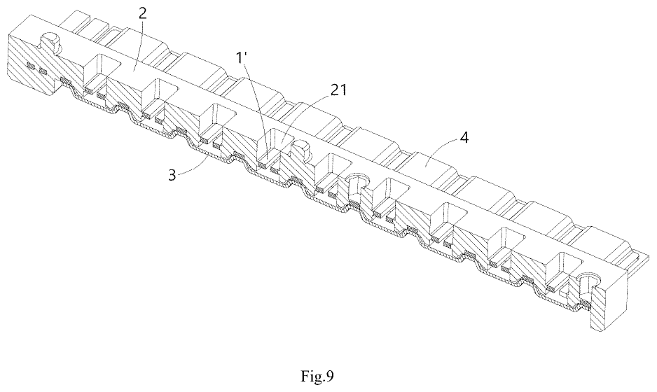

FIG. 1 shows an illustrative perspective view of a terminal module 100 according to an exemplary embodiment of the present invention when viewed from the top. FIG. 2 shows an illustrative exploded view of terminal module 100 according to an exemplary embodiment of the present invention when viewed from the top. FIG. 3 shows another illustrative exploded view of the terminal module 100 according to an exemplary embodiment of the present invention when viewed from the top. FIG. 4 shows a transverse cross-sectional view of a terminal module 100 according to an exemplary embodiment of the present invention when viewed from the top. FIG. 5 shows an exploded cross-sectional view of terminal module 100 according to an exemplary embodiment of the present invention when viewed from the top. FIG. 6 shows an illustrative perspective view of terminal module 100 according to an exemplary embodiment of the present invention when viewed from the bottom. FIG. 7 shows an illustrative exploded view of terminal module 100 according to an exemplary embodiment of the present invention when viewed from the bottom. FIG. 8 shows another illustrative exploded view of the terminal module 100 according to an exemplary embodiment of the present invention when viewed from the bottom. FIG. 9 shows a transverse cross-sectional view of a terminal module 100 according to an exemplary embodiment of the present invention when viewed from the bottom.

As shown in FIGS. 1-9, in an exemplary embodiment of the present invention, a terminal module 100 is disclosed. The terminal module 100 includes a row of terminals 1 and a terminal holder 2. Each terminal 1 includes a cantilever portion 11 and a welding portion 12 that are opposite in a longitudinal direction Y, as well as a fixing portion 13 located between the cantilever portion 11 and the welding portion 12. The terminal holder 2 is injection molded onto the fixing portion 13 of a row of terminals 1, so that the row of terminals 1 and the terminal holder 2 become an integrated piece. A row of terminals 1 includes multiple pairs of signal terminals 1′ and multiple grounding terminals 1″ arranged in a transverse direction X, with one grounding terminal 1″ set between adjacent pairs of signal terminals 1′. Multiple windows 21 respectively corresponding to multiple pairs of signal terminals 1′ are formed on the terminal holder 2, and the windows 21 penetrate the terminal holder 2 in a height direction Z, so that a part of the fixing portion 13 of each pair of signal terminals 1′ is exposed through the windows 21.

In the illustrated embodiment, the terminal module 100 further includes a first grounding shield 3 and a second grounding shield 4. The first grounding shield 3 is welded to the top surface of multiple grounding terminals 1″. The second grounding shield 4 is welded to the bottom surface of multiple grounding terminals 1″. The projections of the first grounding shield 3 and the second grounding shield 4 in the height direction Z do not overlap. This non overlapping grounding shield setting can provide as long a metal shield as possible in limited terminal space, improving the grounding shielding effect.

The terminal holder 2 has top and bottom surfaces that are opposite in the height direction Z, and a transverse slot 20 that communicates with multiple windows 21 is formed on the top surface of the terminal holder 2. The top surfaces of the fixing portions 13 of multiple grounding terminals 1″ are exposed through the transverse slot 20. The terminal module 100 also includes a first grounding shield 3, which is accommodated in the transverse slot 20 and welded to the top surfaces of the fixing portions 13 of multiple grounding terminals 1″ to electrically interconnect the multiple grounding terminals 1″.

The first grounding shield 3 is in the form of a strip extending along the transverse direction X and has multiple first welding ribs 30 respectively corresponding to multiple grounding terminals 1″. The multiple first welding ribs 30 extend along the longitudinal direction Y and protrude downward, and the bottom surfaces of the multiple first welding ribs 30 are respectively welded to the top surfaces of the fixing portions 13 of the multiple grounding terminals 1″.

The first welding rib 30 has a pair of inclined first side walls 31 and a first bottom wall 32 located between the bottom of the pair of inclined first side walls 31, such that the cross-section of the first welding rib 30 is in a trumpet shape that opens upwards. The first bottom wall 32 of the first welding rib 30 has a flat bottom surface, and the bottom surface of the first bottom wall 32 of the first welding rib 30 is welded to the top surface of the fixing portion 13 of the grounding terminal 1″.

In the illustrated embodiment, multiple pairs of positioning ribs 22 respectively corresponding to multiple first welding ribs 30 are formed in the transverse slot 20 of the terminal holder 2. An upward flared positioning opening 23 is defined between each pair of positioning ribs 22, and each first welding rib 30 is positioned in the upward flared positioning opening 23 between the corresponding pair of positioning ribs 22.

The first grounding shield 3 also has a first top wall 33 located between the tops of the first side walls 31 of adjacent two first welding ribs 30. The first top wall 33 is spaced apart from the fixing portion 13 of the signal terminal 1′ by a predetermined distance in the height direction Z.

The terminal module 100 further includes a second grounding shield 4, which is welded to the bottom surfaces of the welding portions 12 of multiple grounding terminals 1″ to electrically interconnect the multiple grounding terminals 1″. The second grounding shield 4 is in the form of a strip extending along the transverse direction X and has multiple second welding ribs 40 corresponding to multiple grounding terminals 1″. The multiple second welding ribs 40 extend along the longitudinal direction Y and protrude downward, and the bottom surfaces of the multiple second welding ribs 40 are respectively welded to the bottom surfaces of the welding portions 12 of the multiple grounding terminals 1″.

The second welding rib 40 has a pair of inclined second side walls 41 and a second top wall 42 located between the tops of the pair of inclined second side walls 41, such that the cross-section of the second welding rib 40 is in a downward flared shape. The second top wall 42 of the second welding rib 40 has a flat top surface, and the top surface of the second top wall 42 of the second welding rib 40 is welded to the bottom surface of the welding portion 12 of the grounding terminal 1″.

The second grounding shield 4 also has a second bottom wall 43 located between the bottom of the second side walls 41 of adjacent two second welding ribs 40, and the second bottom wall 43 is spaced apart from the welding portion 12 of the signal terminal 1′ by a predetermined distance in the height direction Z.

In the illustrated embodiment, multiple first protrusions 2a and multiple first insertion holes 2b are formed on the bottom surface of the terminal holder 2. The multiple first protrusions 2a on the bottom surface of the terminal holder 2 of one terminal module 100 are used to respectively engage with the multiple first insertion holes 2b in the bottom surface of the terminal holder 2 of another terminal module 100. The multiple first insertion holes 2b in the bottom surface of the terminal holder 2 of one terminal module 100 are used to respectively engage with the multiple first protrusions 2a on the bottom surface of the terminal holder 2 of another terminal module 100.

First locking protrusions 2c are respectively formed on the two end faces of the terminal holder 2 opposite to each other in the transverse direction X. The first locking protrusions 2c are adapted to engage with first snap slots in a connector housing to lock the terminal module 100 into the connector housing.

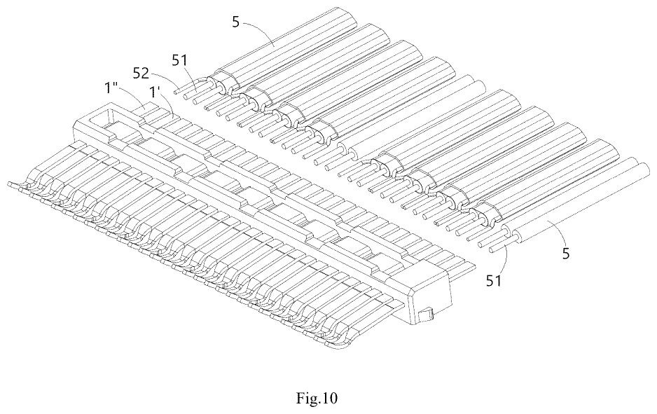

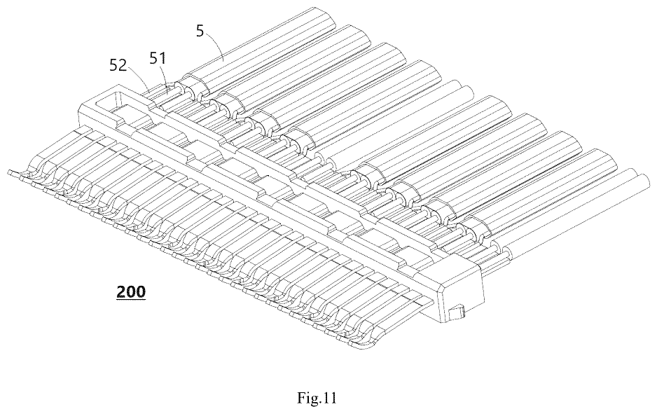

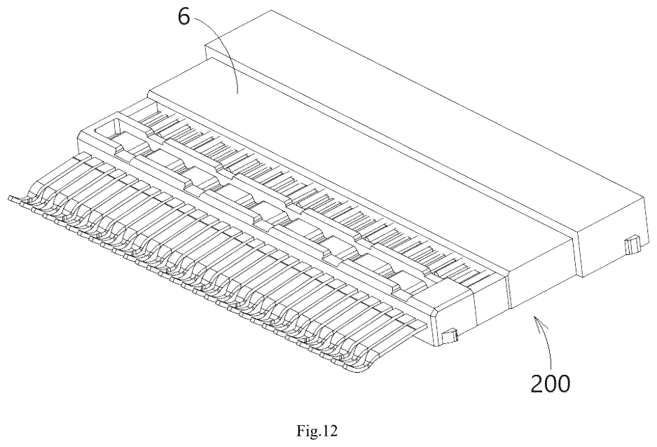

FIG. 10 shows an illustrative exploded view of terminal module 100 and cable 5 according to an exemplary embodiment of the present invention. FIG. 11 shows an illustrative perspective view of terminal module 100 and cable 5 according to an exemplary embodiment of the present invention. FIG. 12 shows an illustrative perspective view of an electrical connection module 200 according to an exemplary embodiment of the present invention.

As shown in FIGS. 1 to 12, in another exemplary embodiment of the present invention, an electrical connection module 200 is also disclosed. The electrical connection module 200 includes the aforementioned terminal module 100 and multiple cables 5. Multiple cables 5 are arranged in a transverse direction X. The signal cables 51 of multiple cables 5 are respectively soldered to the top surfaces of the welding portions 12 of multiple signal terminals 1′ of terminal module 100, and the grounding cables 52 of multiple cables 5 are respectively soldered to the top surfaces of the welding portions 12 of multiple grounding terminals 1″ of terminal module 100.

In the illustrated embodiment, the electrical connection module 200 further includes a cable holder 6, which is injection molded onto multiple cables 5, so that the multiple cables 5 and the cable holder 6 become an integrated piece. The cable holder 6 is also partially injection molded onto the welding portions 12 of a row of terminals 1, so that multiple cables 5, a row of terminals 1, and the cable holder 6 are integrated into one piece.

Multiple second protrusions 6a and multiple second insertion holes 6b are formed on the bottom surface of the cable holder 6. The multiple second protrusions 6a on the bottom surface of the cable holder 6 of one electrical connection module 200 are used to respectively engage with the multiple second insertion holes 6b in the bottom surface of the cable holder 6 of another electrical connection module 200. The multiple second insertion holes 6b in the bottom surface of the cable holder 6 of one electrical connection module 200 are used to respectively engage with the multiple second protrusions 6a on the bottom surface of the cable holder 6 of another electrical connection module 200.

Second locking protrusions 6c are respectively formed on the two end faces of the cable holder 6 opposite to each other in the transverse direction X. The second locking protrusions 6c are adapted to engage with second snap slots (not shown) in the connector housing (not shown) to lock the electrical connection module 200 into the connector housing.

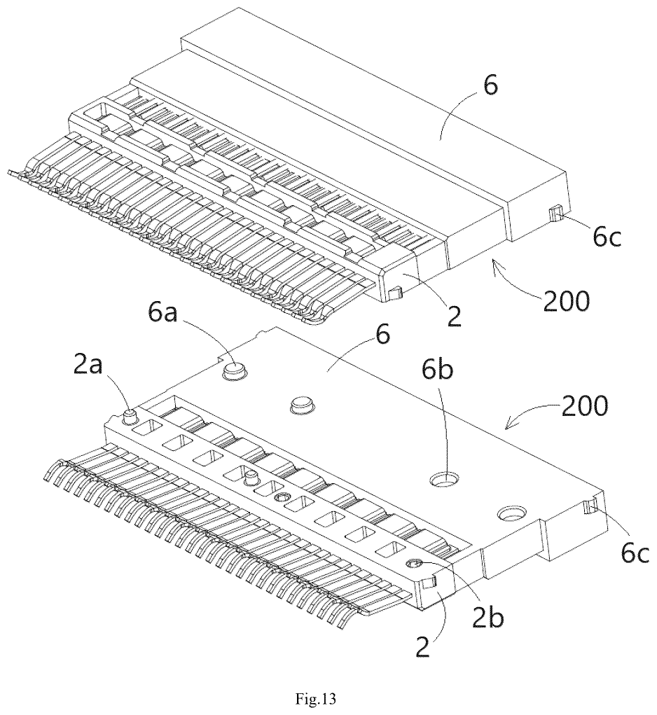

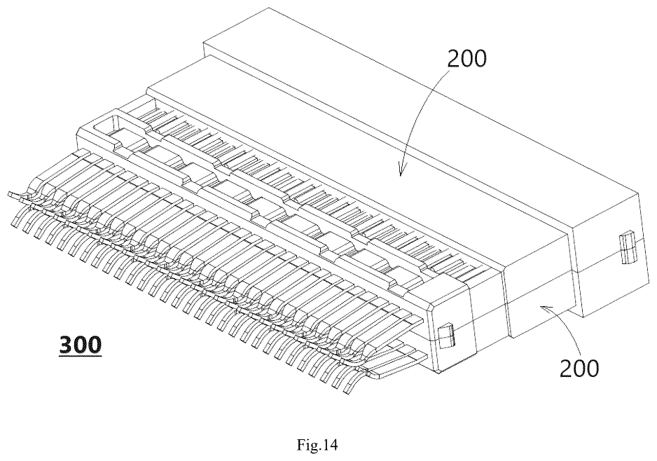

FIG. 13 shows an illustrative exploded view of an electrical connection assembly 300 according to an exemplary embodiment of the present invention. FIG. 14 shows an illustrative perspective view of an electrical connection assembly 300 according to an exemplary embodiment of the present invention.

As shown in FIGS. 1 to 14, in another exemplary embodiment of the present invention, an electrical connection assembly 300 is also disclosed. The electrical connection assembly 300 includes two aforementioned electrical connection modules 200. Two electrical connection modules 200 are assembled together.

The first protrusion 2a and the first insertion hole 2b on the bottom surface of the terminal holder 2 of one electrical connection module 200 are respectively engaged with the first insertion hole 2b and the first protrusion 2a on the bottom surface of the terminal holder 2 of the other electrical connection module 200. The second protrusion 6a and the second insertion hole 6b on the bottom surface of the cable holder 6 of one electrical connection module 200 are respectively engaged with the second insertion hole 6b and the second protrusion 6a on the bottom surface of the cable holder 6 of the other electrical connection module 200.

As shown in FIGS. 1 to 14, in another exemplary embodiment of the present invention, a connector is also disclosed. The connector includes a connector housing and an electrical connection assembly 300. The electrical connection assembly 300 is inserted into the connector housing.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal module, comprising:
a row of terminals including multiple pairs of signal terminals and multiple grounding terminals arranged in a transverse direction, with one grounding terminal set between adjacent pairs of signal terminals, each terminal comprising a cantilever portion and a welding portion opposite in a longitudinal direction, and a fixing portion located between the cantilever portion and the welding portion; and
a terminal holder which is injection molded onto the fixing portions of the row of terminals, so that the row of terminals and the terminal holder become an integrated piece, multiple windows corresponding to the multiple pairs of signal terminals are formed on the terminal holder, and the windows penetrate the terminal holder in a height direction, so that a part of the fixing portions of each pair of signal terminals is exposed through the window.

2. The terminal module according to claim 1, further comprising:
a first grounding shield welded to the top surfaces of the multiple grounding terminals; and
a second grounding shield welded to the bottom surfaces of the multiple grounding terminals, wherein the projections of the first grounding shield and the second grounding shield in the height direction do not overlap.

3. The terminal module according to claim 2, wherein:
the terminal holder has top and bottom surfaces that are opposite in the height direction, and a transverse slot is formed on the top surface of the terminal holder that is communicated with the multiple windows; and
the top surfaces of the fixing portions of the multiple grounding terminals are exposed through the transverse slot, and the first grounding shield is accommodated in the transverse slot and welded to the top surfaces of the fixing portions of the multiple grounding terminals to electrically interconnect the multiple grounding terminals.

4. The terminal module according to claim 3, wherein the first grounding shield is in the form of a strip extending along the transverse direction and has multiple first welding ribs corresponding to the multiple grounding terminals; the multiple first welding ribs extend along the longitudinal direction and protrude downward; the bottom surfaces of the multiple first welding ribs are respectively welded to the top surfaces of the fixing portions of the multiple grounding terminals.

5. The terminal module according to claim 4, wherein:
the first welding rib has a pair of inclined first side walls and a first bottom wall located between the bottom of the pair of inclined first side walls, such that the cross-section of the first welding rib is in a trumpet shape that opens upwards; and
the first bottom wall of the first welding rib has a flat bottom surface, and the flat bottom surface of the first bottom wall of the first welding rib is welded to the top surface of the fixing portion of the grounding terminal.

6. The terminal module according to claim 5, wherein multiple pairs of positioning ribs corresponding to the multiple first welding ribs are formed in the transverse slot of the terminal holder, and an upward flared positioning opening is defined between each pair of positioning ribs; each first welding rib is positioned in the flared positioning opening between the corresponding pair of positioning ribs.

7. The terminal module according to claim 5, wherein the first grounding shield also has a first top wall located between the tops of the first side walls of adjacent first welding ribs, and the first top wall is spaced apart from the fixing portion of the signal terminal by a predetermined distance in the height direction.

8. The terminal module according to claim 1, wherein the second grounding shield is in the form of a strip extending along the transverse direction and has multiple second welding ribs corresponding to the multiple grounding terminals; the multiple second welding ribs extend along the longitudinal direction and protrude downward; the bottom surfaces of the multiple second welding ribs are respectively welded to the bottom surfaces of the welding portions of the multiple grounding terminals.

9. The terminal module according to claim 8, wherein:
the second welding rib has a pair of inclined second side walls and a second top wall located between the tops of the pair of inclined second side walls, such that the cross-section of the second welding rib is in a downward flared shape; and
the second top wall of the second welding rib has a flat top surface, and the flat top surface of the second top wall of the second welding rib is welded to the bottom surface of the welding portion of the grounding terminal.

10. The terminal module according to claim 8, wherein the second grounding shield also has a second bottom wall located between the bottoms of the second side walls of adjacent two second welding ribs, and the second bottom wall is spaced apart from the welding portion of the signal terminal by a predetermined distance in the height direction.

11. The terminal module according to claim 3, wherein:
multiple first protrusions and multiple first insertion holes are formed on the bottom surface of the terminal holder;
multiple first protrusions on the bottom surface of the terminal holder of one terminal module are used to respectively engage with multiple first insertion holes on the bottom surface of the terminal holder of another terminal module; and
multiple first insertion holes on the bottom surface of the terminal holder of one terminal module are used to respectively engage with multiple first protrusions on the bottom surface of the terminal holder of another terminal module.

12. The terminal module according to claim 11, wherein first locking protrusions are respectively formed on the two end faces opposite to each other in the transverse direction of the terminal holder, and the first locking protrusion is adapted to engage with a first snap slot in the connector housing to lock the terminal module into the connector housing.

13. An electrical connection module, comprising:
a terminal module, comprising:
a row of terminals including multiple pairs of signal terminals and multiple grounding terminals arranged in a transverse direction, with one grounding terminal set between adjacent pairs of signal terminals, each terminal comprising a cantilever portion and a welding portion opposite in a longitudinal direction, and a fixing portion located between the cantilever portion and the welding portion; and
a terminal holder which is injection molded onto the fixing portions of the row of terminals, so that the row of terminals and the terminal holder become an integrated piece, multiple windows corresponding to the multiple pairs of signal terminals are formed on the terminal holder, and the windows penetrate the terminal holder in a height direction, so that a part of the fixing portions of each pair of signal terminals is exposed through the window; and
multiple cables arranged in a transverse direction, wherein the signal cables of the multiple cables are respectively soldered to the top surfaces of the welding portions of the multiple signal terminals of the terminal module, and the grounding cables of the multiple cables are respectively soldered to the top surfaces of the welding portions of the multiple grounding terminals of the terminal module.

14. The electrical connection module according to claim 13, further comprising a cable holder which is injection molded onto the multiple cables, so that the multiple cables and the cable holder become an integrated piece.

15. The electrical connection module according to claim 14, wherein the cable holder is also partially injection molded onto the welding portions of the row of terminals, making the multiple cables, the row of terminals, and the cable holder an integrated piece.

16. The electrical connection module according to claim 14, wherein:
multiple second protrusions and multiple second insertion holes are formed on the bottom surface of the cable holder;
multiple second protrusions on the bottom surface of the cable holder of one electrical connection module are used to respectively engage with multiple second insertion holes on the bottom surface of the cable holder of another electrical connection module; and
multiple second insertion holes on the bottom surface of the cable holder of one electrical connection module are used to respectively engage with multiple second protrusions on the bottom surface of the cable holder of another electrical connection module.

17. The electrical connection module according to claim 14, wherein second locking protrusions are respectively formed on the two end faces opposite to each other in the transverse direction of the cable holder, and the second locking protrusion is adapted to engage with a second snap slot in the connector housing to lock the electrical connection module into the connector housing.

18. An electrical connection assembly, comprising two electrical connection modules as claimed in claim 13, which are assembled together.

19. The electrical connection assembly according to claim 18, wherein:
the first protrusion and the first insertion hole on the bottom surface of the terminal holder of one electrical connection module are respectively engaged with the first insertion hole and the first protrusion on the bottom surface of the terminal holder of the other electrical connection module; and
the second protrusion and the second insertion hole on the bottom surface of the cable holder of one electrical connection module are respectively engaged with the second insertion hole and the second protrusion on the bottom surface of the cable holder of the other electrical connection module.

20. A connector, comprising:
a connector housing; and
the electrical connection assembly as claimed in claim 19, which is inserted into the connector housing.
